(19) United States
(12) Patent Application Publication
(10) Pub. No.: US 2026/0124835 A1
(43) Pub. Date: May 7, 2026

(54) TANK UNIT AND LIQUID EJECTION APPARATUS

(71) Applicant: SEIKO EPSON CORPORATION, TOKYO (JP)

(72) Inventors: Seiya SATO, Matsumoto-shi (JP); Hiromichi TAKANASHI, Shiojiri-shi (JP); Seiji TOJO, SHIOJIRI-SHI (JP)

(21) Appl. No.: 19/382,377

(22) Filed: Nov. 7, 2025

(30) Foreign Application Priority Data
Nov. 7, 2024 (JP) 2024-195132

(51) Int. Cl. B41J 2/175

(52) U.S. Cl. CPC B41J 2/17523; B41J 2/17509; B41J 2/17513; B41J 2/17556; B41J 2/17596

(57) ABSTRACT

A tank unit includes a reservoir configured to store a liquid, an inflow section configured to cause the liquid to flow into the reservoir from a liquid container with a water head difference, and an atmospheric opening portion configured to open an inside of the reservoir to an atmosphere, wherein the reservoir includes a storage body configured to define a storage space in which the liquid is stored, and a partition plate configured to partition the storage space into a first chamber and a second chamber, the first chamber is a space that is located above the second chamber and communicates with the atmosphere with the atmospheric opening portion, the inflow section includes an inflow pipe which extends from the storage body toward an inside of the storage body and in which an inflow port communicating with the second chamber opens, and a through hole configured to communicate the first chamber and the second chamber with each other opens in the partition plate.

The present application is based on, and claims priority from JP Application Serial Number 2024-195132, filed Nov. 7, 2024, the disclosure of which is hereby incorporated by reference herein in its entirety.

### BACKGROUND

### 1. Technical Field

The present disclosure relates to a tank unit and a liquid ejection apparatus.

### 2. Related Art

JP-A-2023-59392 describes a liquid ejection apparatus including a head that ejects a liquid and a tank unit that stores the liquid to be supplied to the head. The tank unit is coupled to a liquid container that contains the liquid. When a liquid level in the tank unit is lowered, the liquid is supplied from the liquid container to the tank unit.

JP-A-2023-59392 is an example of the related art.

In such a liquid ejection apparatus, the liquid level in the tank unit may be inclined in some cases due to a change in posture or an occurrence of acceleration or deceleration during transportation. In this case, there is a concern that the liquid is supplied more than necessary from the liquid container to the tank unit by the liquid level being lowered. When the tank unit stores a larger amount of liquid than usual, there is a concern that the ejection performance of the head may be affected by a change in the water head difference between the tank unit and the head.

### SUMMARY

A tank unit that solves the problems described above is a tank unit configured to be supplied with a liquid from a liquid container and configured to store the liquid to be supplied to a head configured to eject the liquid, the tank unit including a reservoir configured to store the liquid, an inflow section configured to cause the liquid to flow into the reservoir from the liquid container with a water head difference, and an atmospheric opening portion configured to open an inside of the reservoir to an atmosphere, wherein the reservoir includes a storage body configured to define a storage space in which the liquid is stored, and a partition plate configured to partition the storage space into a first chamber and a second chamber, the first chamber is a space that is located above the second chamber and communicates with the atmosphere with the atmospheric opening portion, the inflow section includes an inflow pipe which extends from the storage body toward an inside of the storage body and in which an inflow port communicating with the second chamber opens, and a through hole configured to communicate the first chamber and the second chamber with each other opens in the partition plate.

A liquid ejection apparatus that solves the problems described above includes the tank unit described above and the head.

### BRIEF DESCRIPTION OF THE DRAWINGS

FIG. 1 is a schematic diagram illustrating an example of a liquid ejection apparatus including a tank unit.

FIG. 2 is a front view of the tank unit.

FIG. 3 is a side view of the tank unit.

FIG. 4 is a side view from an opposite side to the side of the view in FIG. 3.

FIG. 5 is a cross-sectional view along the line 5-5 shown in FIG. 3.

FIG. 6 is a perspective view of the tank unit shown in FIG. 5.

FIG. 7 is a perspective view from an angle different from the angle of the view in FIG. 6.

FIG. 8 is a perspective view of the tank unit showing insides of atmospheric opening portions.

FIG. 9 is a perspective view from an angle different from the angle of the view in FIG. 8.

FIG. 10 is a perspective view from an angle different from the angles of the views in FIGS. 8 and 9.

FIG. 11 is a perspective view from an angle different from the angles of the views in FIGS. 8, 9, and 10.

FIG. 12 is a cross-sectional view along the line 12-12 shown in FIG. 2.

FIG. 13 is a cross-sectional view along the line 13-13 shown in FIG. 3.

FIG. 14 is a schematic diagram showing when the liquid level is inclined about an imaginary axis extending in a second direction.

FIG. 15 is a schematic diagram showing when the liquid level is inclined in an opposite direction to the inclination direction in FIG. 14.

FIG. 16 is a schematic diagram showing when the liquid level is inclined about an imaginary axis extending in a first direction.

FIG. 17 is a schematic diagram showing when the liquid level is inclined in an opposite direction to the inclination direction in FIG. 16.

### DESCRIPTION OF EMBODIMENTS

An example of a liquid ejection apparatus including a tank unit will hereinafter be described with reference to the drawings. The liquid ejection apparatus is an inkjet printer that ejects an image such as characters or photographs by ejecting ink, which is an example of a liquid, onto a medium such as paper, fabric, or a film.

### Liquid Ejection Apparatus

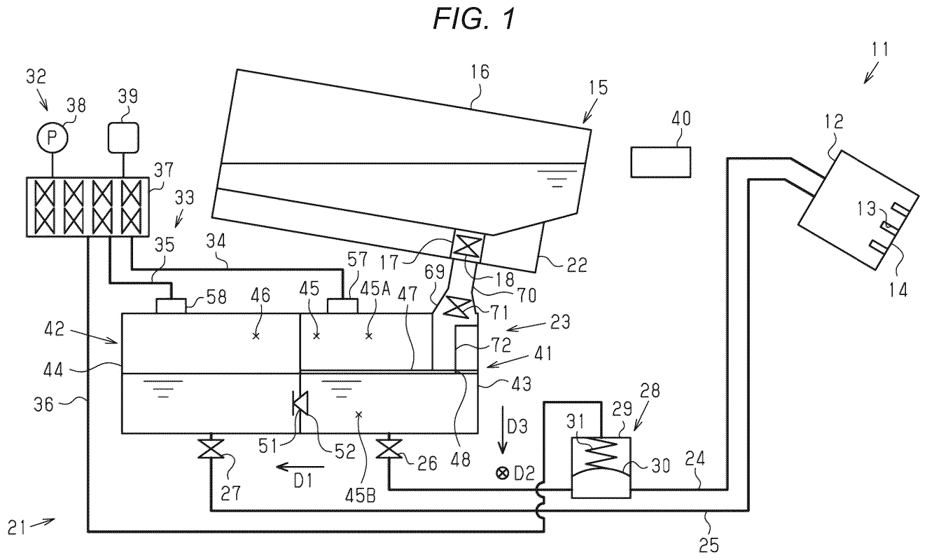

As illustrated in FIG. 1, the liquid ejection apparatus 11 includes a head 12. The head 12 is configured to eject the liquid. The head 12 prints the image on the medium by ejecting the liquid onto the medium. The head 12 has a nozzle surface 14 on which one or more nozzles 13 open. The head 12 is configured so as to eject the liquid from the nozzle 13. In one example, the head 12 is a line head capable of simultaneously ejecting the liquid over the width of the medium. The head 12 may be a serial head configured so as to scan the medium.

The liquid ejection apparatus 11 is configured so as to be attached with a liquid container 15. The liquid container 15 is configured to contain the liquid. The liquid container 15 is, for example, an ink cartridge. When the liquid container 15 is attached to the liquid ejection apparatus 11, the liquid can be supplied from the liquid container 15 to the liquid ejection apparatus 11.

The liquid container 15 includes a containing member 16. The containing member 16 is a member that defines a space for containing the liquid. The liquid container 15 includes an outflow pipe 17. The outflow pipe 17 extends from the containing member 16. The outflow pipe 17 communicates with an inside and an outside of the containing member 16. As air flows into the containing member 16 through the outflow pipe 17, the liquid flows out from the containing member 16 through the outflow pipe 17.

The liquid container 15 includes an outflow valve 18. The outflow valve 18 is a valve located in the outflow pipe 17. When the outflow valve 18 is opened, the liquid can flow out from the containing member 16 through the outflow pipe 17. By the liquid container 15 being attached to the liquid ejection apparatus 11, the outflow valve 18 opens.

The liquid ejection apparatus 11 includes a supply mechanism 21. The supply mechanism 21 is configured so as to supply the liquid from the liquid container 15 toward the head 12. The supply mechanism 21 supplies the liquid while maintaining the inside of the head 12 at negative pressure. The supply mechanism 21 maintains the inside of the head 12 at the negative pressure due to a water head difference. By maintaining the inside of the head 12 at the negative pressure, a meniscus is provided to the nozzle 13. Accordingly, the head 12 can appropriately eject the liquid. The supply mechanism 21 may be configured so as to circulate the liquid between the liquid container 15 and the head 12. By the supply mechanism 21 circulating the liquid, sedimentation of the liquid is resolved.

The supply mechanism 21 includes an attachment portion 22. The attachment portion 22 is configured so as to be attached with the liquid container 15. The attachment portion 22 supports the liquid container 15 attached thereto. When the liquid container 15 is attached to the attachment portion 22, the liquid can be supplied from the liquid container 15 to the supply mechanism 21.

The supply mechanism 21 includes a tank unit 23. The tank unit 23 is configured to be supplied with the liquid from the liquid container 15. The tank unit 23 receives the liquid from the liquid container 15 attached to the attachment portion 22. The tank unit 23 is configured so as to store the liquid. Specifically, the tank unit 23 is configured to store the liquid to be supplied to the head 12. The tank unit 23 temporarily stores the liquid in the process of being supplied from the liquid container 15 to the head 12.

The tank unit 23 is configured such that the inside thereof is opened to the atmosphere. The supply mechanism 21 maintains the inside of the head 12 at the negative pressure due to the water head difference between the tank unit 23 and the head 12. Specifically, the tank unit 23 is configured to store the liquid such that the liquid level in the tank unit 23 is located below the head 12. In one example, the tank unit 23 is configured to store the liquid such that the liquid level in the tank unit 23 is located below the nozzle surface 14.

The tank unit 23 is configured to have a rectangular parallelepiped shape or to be shaped like a rectangular parallelepiped. The tank unit 23 is configured to be shaped like, for example, a rectangular parallelepiped extending in one direction. The tank unit 23 is configured to extend horizontally in the liquid ejection apparatus 11. In one example, the tank unit 23 is located so as to extend in a first direction D1 in the liquid ejection apparatus 11. The tank unit 23 has a shape elongated in the first direction D1. The first direction D1 is a direction extending horizontally. The first direction D1 is a direction perpendicular to a side surface of the tank unit 23. The first direction D1 is a direction from which the tank unit 23 is viewed as a side view. The tank unit 23 has a rectangular shape when viewed from a second direction D2. The second direction D2 is a direction extending horizontally. The second direction D2 is a direction different from the first direction D1. The second direction D2 is a direction perpendicular to a front surface of the tank unit 23. The second direction D2 is a direction from which the tank unit 23 is viewed as a front view. The first direction D1 and the second direction D2 are directions different from a vertical direction D3. A configuration of the tank unit 23 will be described later again.

The supply mechanism 21 has one or more connection flow paths. In one example, the supply mechanism 21 includes a first connection flow path 24 and a second connection flow path 25. The connection flow path is a flow path to be coupled to the tank unit 23. The connection flow path is a flow path to be coupled to the head 12. The connection flow path is a flow path that connects the tank unit 23 and the head 12 to each other.

The supply mechanism 21 supplies the liquid from the tank unit 23 to the head 12 through the connection flow path. In one example, the supply mechanism 21 supplies the liquid from the tank unit 23 to the head 12 through both the first connection flow path 24 and the second connection flow path 25 during printing.

The supply mechanism 21 may return the liquid from the head 12 to the tank unit 23 through the connection flow path. The supply mechanism 21 may circulate the liquid in the tank unit 23 and the head 12 with, for example, the first connection flow path 24 and the second connection flow path 25. In one example, during the circulation, the supply mechanism 21 sends the liquid from the head 12 to the tank unit 23 through the first connection flow path 24, and sends the liquid from the tank unit 23 to the head 12 through the second connection flow path 25.

The supply mechanism 21 includes one or more connection valves. In one example, the supply mechanism 21 includes a first connection valve 26 and a second connection valve 27. The connection valve is a valve located in the connection flow path. The connection valve opens and closes the connection flow path. The connection valve is, for example, an electromagnetic valve. The first connection valve 26 is located in the first connection flow path 24. The first connection valve 26 opens and closes the first connection flow path 24. The second connection valve 27 is located in the second connection flow path 25. The second connection valve 27 opens and closes the second connection flow path 25.

The supply mechanism 21 may include a pressurizing unit 28. The pressurizing unit 28 is located in the connection flow path. In one example, the pressurizing unit 28 is located in the first connection flow path 24. The pressurizing unit 28 is configured to pressurize the inside of the head 12. The pressurizing unit 28 pressurizes the inside of the head 12 through the connection flow path. The pressurizing unit 28 includes a pump. The pressurizing unit 28 includes, for example, a diaphragm pump. The pressurizing unit 28 includes a pump member 29, a diaphragm 30, and a pressing member 31. The pump member 29 houses the diaphragm 30 and the pressing member 31. The diaphragm 30 partitions an inside of the pump member 29 into a liquid chamber and an air chamber. The pressing member 31 presses the diaphragm 30 so as to reduce the volume of the liquid chamber.

The pressurizing unit 28 performs maintenance on the head 12 by pressurizing the inside of the head 12. In one example, the pressurizing unit 28 pressurizes the inside of the head 12 through the connection flow path by the pressing member 31 pressing the diaphragm 30. When the pressurizing unit 28 pressurizes the inside of the head 12 through the first connection flow path 24, the first connection valve 26 is preferably closed. By the pressurizing unit 28 pressurizing the inside of the head 12, the liquid is forcibly discharged from the head 12 through the nozzle 13. As a result, thickened liquid, foreign matter, and the like are discharged from the head 12.

The supply mechanism 21 may include a pressure adjustment unit 32. The pressure adjustment unit 32 may be coupled to the tank unit 23. The pressure adjustment unit 32 may be coupled to the pressurizing unit 28. The pressure adjustment unit 32 may be configured to adjust the pressure in the tank unit 23. The pressure adjustment unit 32 may be configured to adjust the pressure in the pressurizing unit 28.

The pressure adjustment unit 32 may be configured to pressurize an inside of the tank unit 23. The pressure adjustment unit 32 may maintain the head 12 by pressurizing the inside of the tank unit 23. The pressure adjustment unit 32 pressurizes the inside of the head 12 through the connection flow path by pressurizing the inside of the tank unit 23. As a result, thickened liquid, foreign matter, and the like are discharged from the head 12. Maintenance intensity of the head 12 by the pressure adjustment unit 32 pressurizing the inside of the tank unit 23 is higher than the maintenance intensity of the head 12 by the pressurizing unit 28 pressurizing the inside of the head 12.

The pressure adjustment unit 32 may be configured to depressurize the inside of the tank unit 23. The pressure adjustment unit 32 may return the liquid from the head 12 to the tank unit 23 by depressurizing the inside of the tank unit 23. The pressure adjustment unit 32 may circulate the liquid by depressurizing the inside of the tank unit 23.

The pressure adjustment unit 32 may be configured to depressurize an inside of the pressurizing unit 28. The pressure adjustment unit 32 may drive the pressurizing unit 28 by depressurizing the inside of the pressurizing unit 28. For example, the pressure adjustment unit 32 depressurizes the air chamber in the pressurizing unit 28. Accordingly, the diaphragm 30 is displaced such that the volume of the liquid chamber increases. On this occasion, the liquid flows into the pressurizing unit 28 from the tank unit 23 and the head 12. When the pressure adjustment unit 32 stops depressurizing the pressurizing unit 28, the diaphragm 30 is displaced so as to reduce the volume of the liquid chamber. Accordingly, the liquid flows from the pressurizing unit 28 to the head 12. As a result, the inside of the head 12 is pressurized.

The pressure adjustment unit 32 includes an opening-closing section 33. The opening-closing section 33 is configured to open and close the tank unit 23 with respect to the outside. The opening-closing section 33 is configured to open the inside of the tank unit 23 to the atmosphere or block the inside thereof from the atmosphere. The opening-closing section 33 may be configured to open and close the pressurizing unit 28 with respect to the outside. The opening-closing section 33 may be configured to open the inside of the pressurizing unit 28 to the atmosphere or block the inside of the pressurizing unit 28 from the atmosphere.

The opening-closing section 33 has one or more air flow paths. In one example, the opening-closing section 33 includes a first air flow path 34, a second air flow path 35, and a third air flow path 36. The plurality of air flow paths may be coupled to each other. The first air flow path 34 is coupled to the tank unit 23. The second air flow path 35 is coupled to the tank unit 23. The third air flow path 36 is coupled to the pressurizing unit 28. The air flow path is a flow path through which air flows. The pressure adjustment unit 32 adjusts the pressure in the tank unit 23 or the pressure in the pressurizing unit 28 through the air flow path.

The opening-closing section 33 may include a selector valve 37. The selector valve 37 is configured to open and close the air flow path. The selector valve 37 opens and closes the air flow path to thereby open and close the inside of the tank unit 23 with respect to the outside or open and close the inside of the pressurizing unit 28 with respect to the outside.

The selector valve 37 may be configured to switch the connection destination of the air flow path. For example, in addition to opening and closing the air flow path, the opening-closing section 33 may communicate with another air flow path, a pump, a sensor, or the like.

The pressure adjustment unit 32 may include an air pump 38. The air pump 38 is configured to cause air to flow. The air pump 38 is, for example, a tube pump. The air pump 38 is coupled to the air flow path. The air pump 38 is coupled to the first air flow path 34, the second air flow path 35, or the third air flow path 36. The connection destination of the air pump 38 is switched by the selector valve 37. The air pump 38 can feed air into the first air flow path 34, the second air flow path 35, and the third air flow path 36, and can draw air from the first air flow path 34, the second air flow path 35, and the third air flow path 36.

The pressure adjustment unit 32 may include a pressure sensor 39. The pressure sensor 39 is configured to measure the pressure of the air flow path. The pressure sensor 39 is coupled to the air flow path. The pressure sensor 39 is coupled to the first air flow path 34, the second air flow path 35, or the third air flow path 36. The connection destination of the pressure sensor 39 is switched by the selector valve 37. The pressure sensor 39 measures the pressure in the tank unit 23 through the first air flow path 34, the second air flow path 35, and the like. The pressure sensor 39 measures the pressure in the pressurizing unit 28 through the third air flow path 36.

The liquid ejection apparatus 11 includes a controller 40. The controller 40 is configured to control the liquid ejection apparatus 11. The controller 40 controls, for example, the head 12 and the supply mechanism 21.

The controller 40 is configured to receive an instruction from an operation panel, a communication terminal, or the like. The controller 40 is configured to receive, for example, a print instruction, a transportation instruction, and so on from a user. The print instruction is an instruction to cause the controller 40 to print an image. The transportation instruction is an instruction for notifying the controller 40 of the fact that the liquid ejection apparatus 11 is to be transported. The controller 40 controls the liquid ejection apparatus 11 based on the print instruction, the transportation instruction, and so on. During transportation, the liquid level in the tank unit 23 may be inclined in some cases due to a change in the posture of the liquid ejection apparatus 11 or inertia acting on the liquid ejection apparatus 11. Therefore, when the transportation instruction is received, the controller 40 controls the liquid ejection apparatus 11 to be in a state of preparing for transport. For example, when the transportation instruction is received, the controller 40 may control the liquid ejection apparatus 11 so as to be in a state in which the liquid does not leak. Upon reception of the transportation instruction, the controller 40 may control the connection valve or may control the opening-closing section 33.

The controller 40 may be configured with one or more processors that execute various types of processing in accordance with a computer program. The controller 40 may be configured with one or more dedicated hardware circuits such as an ASIC that executes at least some of the various types of processing. The controller 40 may be configured with a circuit including a combination of a processor and a hardware circuit. The processor includes a CPU and memory devices such as a RAM and a ROM. The memory devices store program codes or commands configured to cause the CPU to execute the processing. The memory device, that is, a computer-readable medium includes any readable medium that can be accessed by a general-purpose or dedicated computer.

### Tank Unit

Then, a configuration of the tank unit 23 will be described.

The tank unit 23 includes one or more reservoirs. In one example, the tank unit 23 includes a first reservoir 41 and a second reservoir 42. The reservoir is configured to store the liquid. The first reservoir 41 and the second reservoir 42 are integrally formed. The first reservoir 41 and the second reservoir 42 are arranged in, for example, a horizontal direction. In one example, the first reservoir 41 and the second reservoir 42 are arranged in this order in the first direction D1.

The tank unit 23 is configured such that the liquid flows from the first reservoir 41 to the second reservoir 42. The first reservoir 41 and the second reservoir 42 are coupled to each other. The first reservoir 41 is configured to be supplied with the liquid from the liquid container 15. The first reservoir 41 stores the liquid supplied from the liquid container 15. The first reservoir 41 may store the liquid returned from the head 12. The second reservoir 42 is configured to be supplied with the liquid from the first reservoir 41. The second reservoir 42 stores the liquid supplied from the first reservoir 41. The first reservoir 41 and the second reservoir 42 each store the liquid so that the respective heights of the liquid levels coincide with each other.

The reservoir includes a storage body. The first reservoir 41 includes a first storage body 43. The second reservoir 42 includes a second storage body 44. The storage body is a member that defines a storage space. The storage space is a space in the reservoir. The storage space includes a space in which the liquid is stored. The storage space is a space for storing the liquid together with air. The storage space is a space communicating with the atmosphere. The first storage body 43 defines a first storage space 45. The first storage space 45 is a space in the first reservoir 41. The second storage body 44 defines a second storage space 46. The second storage space 46 is a space in the second reservoir 42.

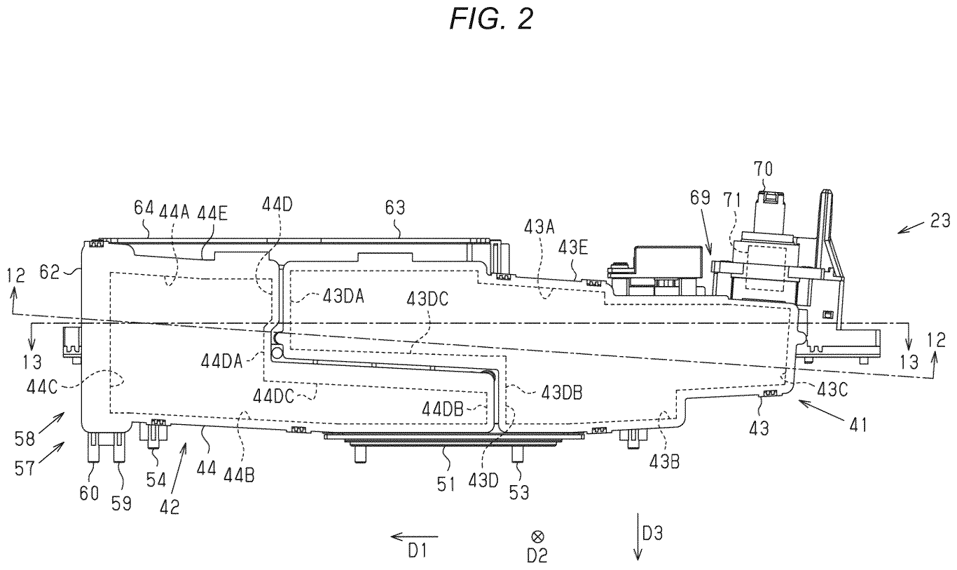

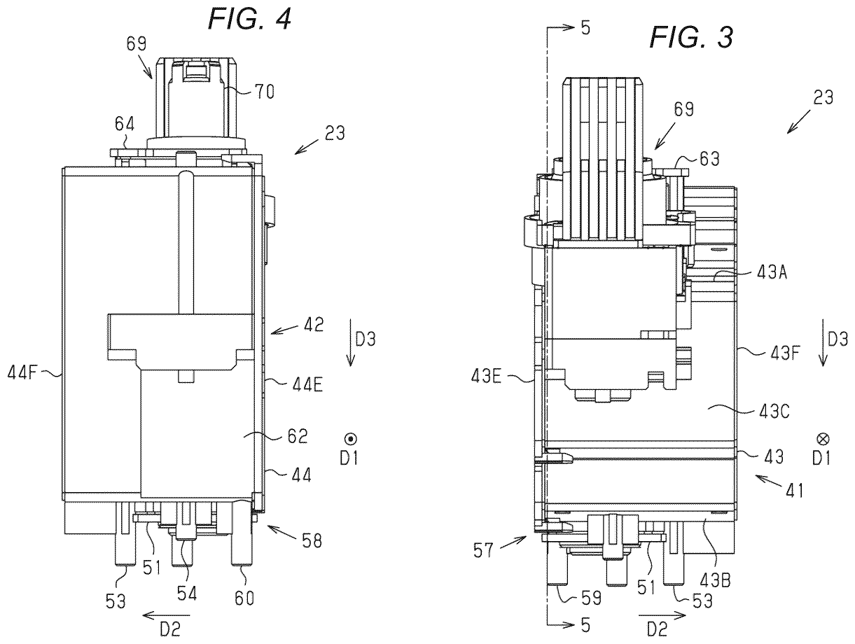

As illustrated in FIGS. 2, 3, 4, and 5, the storage body has a plurality of walls. The plurality of walls defines the storage space. Each of the first storage body 43 and the second storage body 44 has the plurality of walls. The first storage body 43 defines a first storage space 45 with the plurality of walls. The second storage body 44 defines the second storage space 46 with the plurality of walls.

The storage body has an upper wall and a lower wall. The first storage body 43 has a first upper wall 43A and a first lower wall 43B. The second storage body 44 has a second upper wall 44A and a second lower wall 44B. The upper wall and the lower wall face each other. The upper wall and the lower wall spread in a direction perpendicular to the vertical direction D3. The upper wall and the lower wall extend in the first direction D1 when viewed from the second direction D2.

The first upper wall 43A and the first lower wall 43B face each other. The first upper wall 43A and the first lower wall 43B spread in a direction perpendicular to the vertical direction D3. The first upper wall 43A and the first lower wall 43B extend in the first direction D1 when viewed from the second direction D2. The second upper wall 44A and the second lower wall 44B face each other. The second upper wall 44A and the second lower wall 44B spread in a direction perpendicular to the vertical direction D3. The second upper wall 44A and the second lower wall 44B extend in the first direction D1 when viewed from the second direction D2. The first upper wall 43A and the second upper wall 44A may be coupled to each other or may be separated from each other. The first lower wall 43B and the second lower wall 44B may be coupled to each other or may be separated from each other.

The storage body has two sidewalls. Specifically, the storage body has a coupling sidewall and an opposed sidewall. The first storage body 43 has a first coupling sidewall 43C and a first opposed sidewall 43D. The second storage body 44 has a second coupling sidewall 44C and a second opposed sidewall 44D. The coupling sidewall is a wall coupled to the upper wall and the lower wall. The opposed sidewall is a wall coupled to the upper wall and the lower wall. The coupling sidewall and the opposed sidewall are opposed to each other. The coupling sidewall and the opposed sidewall spread in a direction perpendicular to the first direction D1. The coupling sidewall and the opposed sidewall extend in the vertical direction D3 when viewed from the second direction D2.

The first coupling sidewall 43C is coupled to the first upper wall 43A and the first lower wall 43B. The first opposed sidewall 43D is coupled to the first upper wall 43A and the first lower wall 43B. The first coupling sidewall 43C and the first opposed sidewall 43D face each other. The first coupling sidewall 43C and the first opposed sidewall 43D spread in a direction perpendicular to the first direction D1. The first coupling sidewall 43C and the first opposed sidewall 43D extend in the vertical direction D3 when viewed from the second direction D2. The second coupling sidewall 44C is coupled to the second upper wall 44A and the second lower wall 44B. The second opposed sidewall 44D is coupled to the second upper wall 44A and the second lower wall 44B. The second coupling sidewall 44C and the second opposed sidewall 44D face each other. The second coupling sidewall 44C and the second opposed sidewall 44D spread in a direction perpendicular to the first direction D1. The second coupling sidewall 44C and the second opposed sidewall 44D extend in the vertical direction D3 when viewed from the second direction D2. The first coupling sidewall 43C, the first opposed sidewall 43D, the second opposed sidewall 44D, and the second coupling sidewall 44C are arranged in this order in the first direction D1. The first opposed sidewall 43D and the second opposed sidewall 44D may be a common wall or may be independent walls. In one example, the second opposed sidewall 44D extends along the first opposed sidewall 43D.

The opposed sidewall may include an upper sidewall and a lower sidewall. The first opposed sidewall 43D may include a first upper sidewall 43DA and a first lower sidewall 43DB. The second opposed sidewall 44D may include a second upper sidewall 44DA and a second lower sidewall 44DB. The upper sidewall is a portion located in an upper area of the opposed sidewall. The lower sidewall is a portion located in a lower area of the opposed sidewall.

The first upper sidewall 43DA is a portion located in an upper area of the first opposed sidewall 43D. The first lower sidewall 43DB is a portion located in a lower area of the first opposed sidewall 43D. The second upper sidewall 44DA is a portion located in an upper area of the second opposed sidewall 44D. The second lower sidewall 44DB is a portion located in a lower area of the second opposed sidewall 44D.

The upper sidewall and the lower sidewall may be located so as not to overlap vertically. That is, the upper sidewall and the lower sidewall may be located so as not to overlap when viewed from the vertical direction D3. In one example, the first upper sidewall 43DA is located so as to be longer in distance from the first coupling sidewall 43C than the first lower sidewall 43DB. Specifically, when viewed from the second direction D2, the distance from the first coupling sidewall 43C to the first upper sidewall 43DA is longer than the distance from the first coupling sidewall 43C to the first lower sidewall 43DB. Therefore, in the first storage space 45, a volume of a space located in an upper part is larger than a volume of a space located in a lower part. The second upper sidewall 44DA is located so as to be shorter in distance from the second coupling sidewall 44C than the second lower sidewall 44DB. Specifically, when viewed from the second direction D2, the distance from the second coupling sidewall 44C to the second upper sidewall 44DA is shorter than the distance from the second coupling sidewall 44C to the second lower sidewall 44DB. Therefore, in the second storage space 46, a volume of a space located in an upper part is smaller than a volume of a space located in a lower part.

The opposed sidewall may include a joining sidewall. The first opposed sidewall 43D may have a first joining sidewall 43DC. The second opposed sidewall 44D may have a second joining sidewall 44DC. The joining sidewall is a portion coupled to the upper sidewall and the lower sidewall. The joining sidewall extends in the first direction D1 when viewed from the second direction D2. The first joining sidewall 43DC is coupled to the first upper sidewall 43DA and the first lower sidewall 43DB. The first joining sidewall 43DC extends in the first direction D1 when viewed from the second direction D2. The second joining sidewall 44DC is coupled to the second upper sidewall 44DA and the second lower sidewall 44DB. The second joining sidewall 44DC extends in the first direction D1 when viewed from the second direction D2.

The storage body includes a front wall and a back wall. The first storage body 43 includes a first front wall 43E and a first back wall 43F. The second storage body 44 includes a second front wall 44E and a second back wall 44F. The front wall is a wall coupled to the upper wall, the lower wall, the coupling sidewall, and the opposed sidewall. The back wall is a wall coupled to the upper wall, the lower wall, the coupling sidewall, and the opposed sidewall. The front wall and the back wall face each other. The front wall and the back wall spread in a direction perpendicular to the second direction D2. The front wall may be welded to the upper wall, the lower wall, the coupling sidewall, and the opposed sidewall. For example, the front wall may be laser-welded to the upper wall, the lower wall, the coupling sidewall, and the opposed sidewall. The back wall may be a wall constituting a base of the upper wall, the lower wall, the coupling sidewall, and the opposed sidewall. For example, the upper wall, the lower wall, the coupling sidewall, the opposed sidewall, and the back wall may be integrally formed.

The first front wall 43E is a wall coupled to the first upper wall 43A, the first lower wall 43B, the first coupling sidewall 43C, and the first opposed sidewall 43D. The first back wall 43F is a wall coupled to the first upper wall 43A, the first lower wall 43B, the first coupling sidewall 43C, and the first opposed sidewall 43D. The first front wall 43E and the first back wall 43F face each other. The first front wall 43E and the first back wall 43F spread in a direction perpendicular to the second direction D2. The second front wall 44E is a wall coupled to the second upper wall 44A, the second lower wall 44B, the second coupling sidewall 44C, and the second opposed sidewall 44D. The second back wall 44F is a wall coupled to the second upper wall 44A, the second lower wall 44B, the second coupling sidewall 44C, and the second opposed sidewall 44D. The second front wall 44E and the second back wall 44F face each other. The second front wall 44E and the second back wall 44F spread in a direction perpendicular to the second direction D2. The first front wall 43E and the second front wall 44E may be coupled to each other or may be separated from each other. The first back wall 43F and the second back wall 44F may be coupled to each other or may be separated from each other.

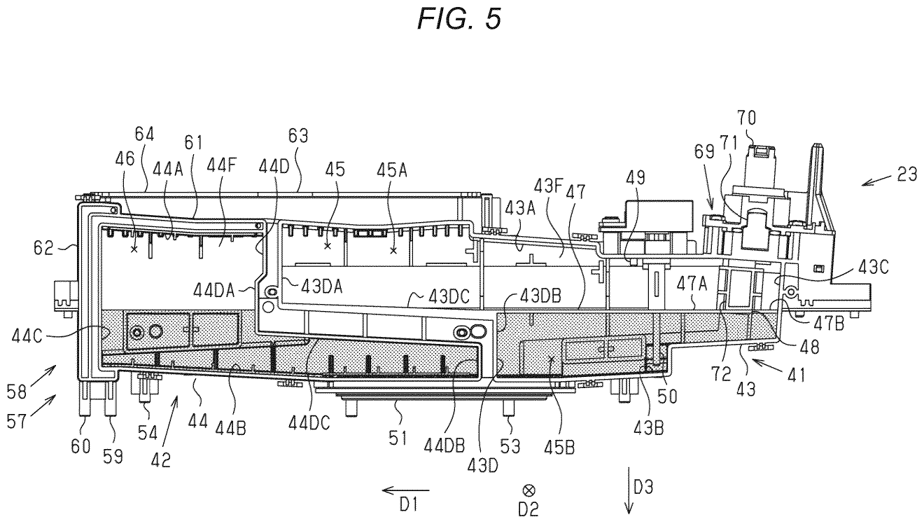

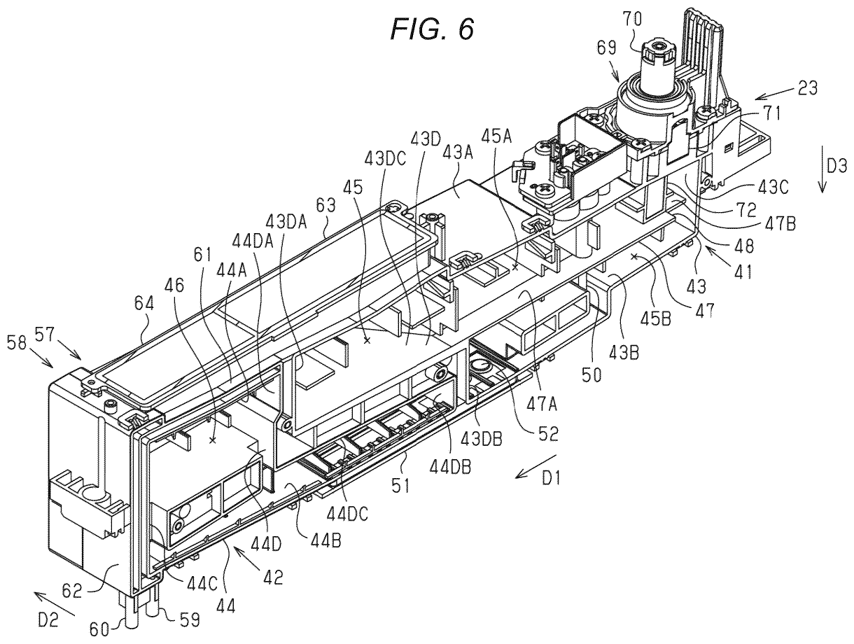

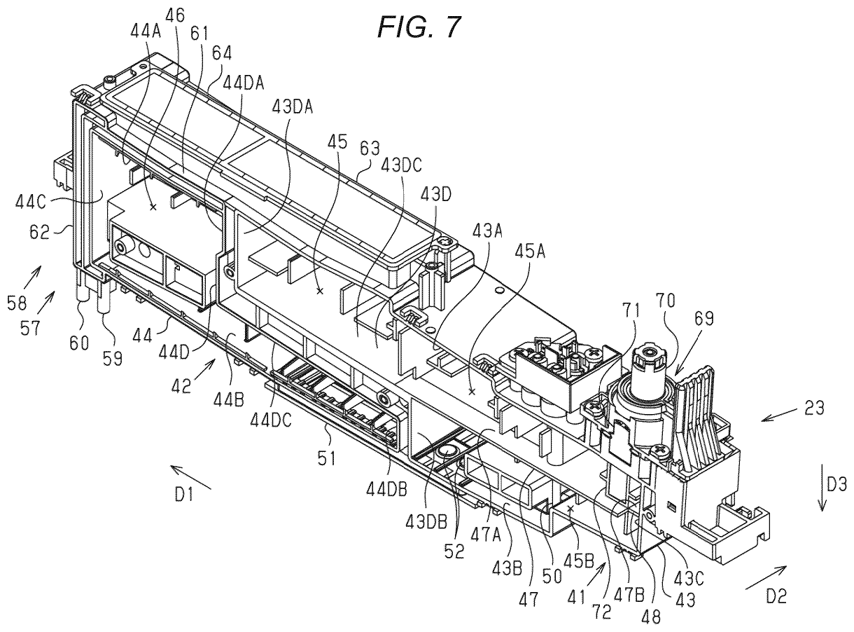

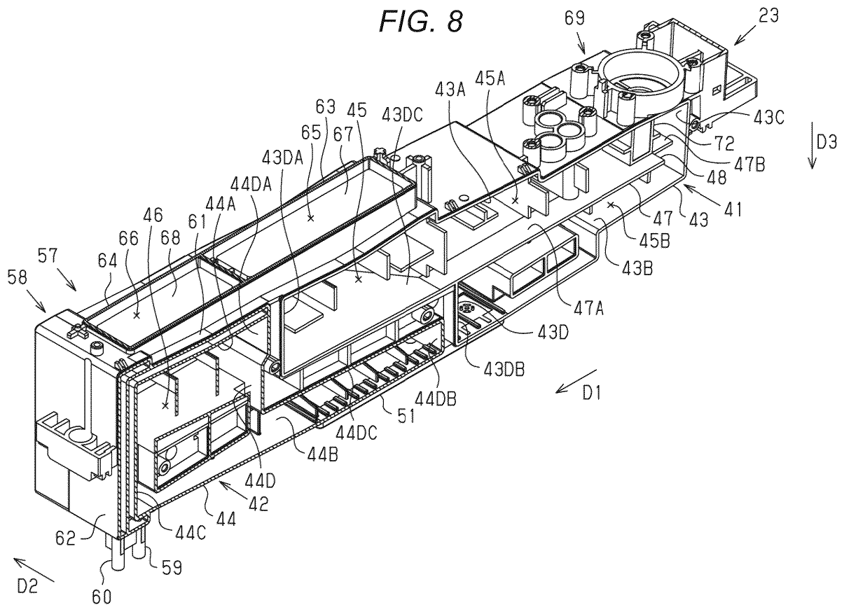

As illustrated in FIGS. 5, 6, 7, and 8, the reservoir includes a partition plate 47. Specifically, the first reservoir 41 includes the partition plate 47. The second reservoir 42 does not include the partition plate 47. The partition plate 47 is a plate that partitions an inside of the first reservoir 41. The partition plate 47 is located in the first reservoir 41.

The partition plate 47 vertically partitions the first storage space 45. The partition plate 47 partitions the first storage space 45 into a first chamber 45A and a second chamber 45B. The first chamber 45A is a space located above the second chamber 45B. The first chamber 45A is a space that mainly stores air. The first chamber 45A is a space communicating with the atmosphere. Specifically, the first chamber 45A is a space communicating with the first air flow path 34. The second chamber 45B is a space for mainly storing the liquid. The second chamber 45B is a space communicating with an inside of the liquid container 15. The second chamber 45B is a space in which the liquid supplied from the liquid container 15 is stored.

The partition plate 47 partitions the first storage space 45 so as to retain the liquid in the second chamber 45B when the liquid level is inclined. In the tank unit 23, the liquid level may be inclined in some cases due to a posture change during transportation, an action of acceleration and deceleration, and so on. In the first reservoir 41, the liquid level may be lowered due to the inclination of the liquid level in some cases. When the liquid level is lowered in the first reservoir 41, the liquid is supplied from the liquid container 15. Therefore, the partition plate 47 retains the liquid in the second chamber 45B when the liquid level is inclined to thereby reduce the possibility that the liquid is supplied to the first reservoir 41 more than necessary.

A volume of the second chamber 45B may be smaller than a volume of the first chamber 45A. When the volume of the second chamber 45B is small, the liquid level is likely to greatly vary with a supply, consumption, and so on of the liquid. Since the liquid level greatly varies, it is easy to figure out an amount of the liquid stored in the first reservoir 41, such as an insufficient amount or an excessive amount. Further, when the volume of the first chamber 45A is large, an excessive liquid can be stored in the first chamber 45A when the liquid is supplied more than necessary.

The first chamber 45A is a space that the first upper sidewall 43DA faces. The first chamber 45A is defined by the first upper wall 43A, the first coupling sidewall 43C, the first upper sidewall 43DA, the first joining sidewall 43DC, the first front wall 43E, the first back wall 43F, and the partition plate 47. The second chamber 45B is a space that the first lower sidewall 43DB faces. The second chamber 45B is defined by the first lower wall 43B, the first coupling sidewall 43C, the first lower sidewall 43DB, the first front wall 43E, the first back wall 43F, and the partition plate 47.

The partition plate 47 extends from the first storage body 43. The partition plate 47 extends from the first coupling sidewall 43C and the first opposed sidewall 43D. The partition plate 47 extends from, for example, the first joining sidewall 43DC. In one example, the partition plate 47 extends continuously from the first joining sidewall 43DC. The partition plate 47 extends so as to extend the first joining sidewall 43DC. The partition plate 47 may extend horizontally. In one example, the partition plate 47 extends in the first direction D1. Since the partition plate 47 extends horizontally, the height of the liquid level of the liquid stored in the first reservoir 41 and the height of the partition plate 47 are likely to coincide with each other. In this case, air is less likely to be stored in the second chamber 45B. Accordingly, in the second chamber 45B, the liquid is less likely to undulate, and thus the liquid is less likely to foam.

A through hole 48 is opened in the partition plate 47. The through hole 48 is an opening through which the first chamber 45A and the second chamber 45B communicate with each other. Air flows from the second chamber 45B to the first chamber 45A through the through hole 48. Accordingly, it becomes easy for the liquid to be smoothly supplied from the liquid container 15 to the second chamber 45B. The through hole 48 is preferably small enough to prevent the liquid stored in the second chamber 45B from forming a meniscus. The smaller the through hole 48 is, the more difficult it is for the liquid to flow from the second chamber 45B to the first chamber 45A. That is, the smaller the through hole 48 is, the more easily the liquid is retained in the second chamber 45B.

In the partition plate 47, it is more difficult for the liquid to flow from the second chamber 45B to the first chamber 45A when the through hole 48 is located so as to communicate with an end of the second chamber 45B than when the through hole 48 is located so as to communicate with the center of the second chamber 45B. Therefore, in the partition plate 47, it is preferable for the through hole 48 to be located at a position adjacent to the first coupling sidewall 43C, the first opposed sidewall 43D, the first front wall 43E, the first back wall 43F, and the like. In this case, even when the liquid level is inclined, the liquid is likely to remain in the second chamber 45B.

The partition plate 47 is configured to have a rectangular shape or to be shaped like a rectangle when viewed from the vertical direction D3. In one example, the through hole 48 is located at a corner portion of the partition plate 47. This makes it difficult for the liquid to flow from the second chamber 45B to the first chamber 45A.

The partition plate 47 may include a first portion 47A and a second portion 47B. The first portion 47A is a portion extending from the first opposed sidewall 43D. Specifically, the first portion 47A is a portion extending from the first joining sidewall 43DC to an inflow pipe 72 described later. The second portion 47B is a portion extending from the first coupling sidewall 43C. Specifically, the second portion 47B is a portion extending from the first coupling sidewall 43C to the inflow pipe 72. The first portion 47A and the second portion 47B do not overlap the inflow pipe 72 when viewed from the second direction D2. The length of the first portion 47A and the length of the second portion 47B may be the same as each other or different from each other. In one example, the first portion 47A is longer than the second portion 47B.

The first portion 47A and the second portion 47B may be coupled to each other or may be separated from each other. For example, the first portion 47A and the second portion 47B may be coupled to each other with a portion overlapping the inflow pipe 72 of the partition plate 47. For example, the first portion 47A and the second portion 47B may be separated from each other by the through hole 48 opening between the first portion 47A and the second portion 47B in the partition plate 47. In one example, the first portion 47A and the second portion 47B are coupled to each other. The through hole 48 opens in the second portion 47B. By the through hole 48 opening in the second portion 47B which is shorter, the liquid becomes difficult to flow from the second chamber 45B to the first chamber 45A.

The tank unit 23 may include one or more liquid sensors. The tank unit 23 includes a first liquid sensor 49 and a second liquid sensor 50. The liquid sensor is configured to detect the liquid. Specifically, the liquid sensor is configured to detect the liquid in the first reservoir 41. The liquid sensor detects the liquid by touching the liquid. The liquid sensor is attached to the first reservoir 41. In one example, the liquid sensor is attached to the first upper wall 43A. The liquid sensor extends from the first upper wall 43A into the first reservoir 41.

The first liquid sensor 49 is located in the first chamber 45A. In one example, the first liquid sensor 49 extends from the first upper wall 43A to the first chamber 45A. The first liquid sensor 49 detects the liquid in the first chamber 45A. The first liquid sensor 49 detects overflow of the tank unit 23 by detecting the liquid in the first chamber 45A. When the first liquid sensor 49 comes into contact with the liquid, there is a possibility that the liquid is retained in the first chamber 45A. In this case, there is a possibility that the liquid is excessively supplied to the tank unit 23. When detecting the overflow, the controller 40 may discharge the liquid in the tank unit 23 through the head 12.

The second liquid sensor 50 is located in the second chamber 45B. In one example, the second liquid sensor 50 extends from the first upper wall 43A to the second chamber 45B. The second liquid sensor 50 extends so as to penetrate the partition plate 47. For example, the second liquid sensor 50 extends so as to penetrate the first portion 47A. The second liquid sensor 50 detects the liquid in the second chamber 45B. When the second liquid sensor 50 fails to detect the liquid in the second chamber 45B, a near-end state of the tank unit 23 is detected. When the second liquid sensor 50 does not come into contact with the liquid, there is a possibility that an amount of the liquid in the second chamber 45B is small. In this case, there is a concern that the liquid is not supplied from the liquid container 15 to the tank unit 23. The controller 40 may announce replacement of the liquid container 15 when the near-end state is detected.

The tank unit 23 includes a joining flow path 51. The joining flow path 51 is a flow path coupled to the first reservoir 41 and the second reservoir 42. In one example, the joining flow path 51 is coupled to the first lower wall 43B and the second lower wall 44B. The joining flow path 51 allows the first storage space 45 and the second storage space 46 to communicate with each other. Specifically, the joining flow path 51 allows the second chamber 45B and the second storage space 46 to communicate with each other. The liquid flows from the first reservoir 41 to the second reservoir 42 through the joining flow path 51.

The tank unit 23 includes a one-way valve 52. The one-way valve 52 is a valve that limits the flow of the liquid in the joining flow path 51 to one direction. The one-way valve 52 is configured to allow the liquid to flow from the first reservoir 41 toward the second reservoir 42 in the joining flow path 51. The one-way valve 52 is configured to suppress a flow from the second reservoir 42 toward the first reservoir 41 in the joining flow path 51. The one-way valve 52 opens when the pressure of the first reservoir 41 is higher than the pressure of the second reservoir 42. The one-way valve 52 opens when, for example, the liquid level of the first reservoir 41 is higher than the liquid level of the second reservoir 42. The one-way valve 52 is, for example, an umbrella valve. In one example, the one-way valve 52 is attached to the first lower wall 43B.

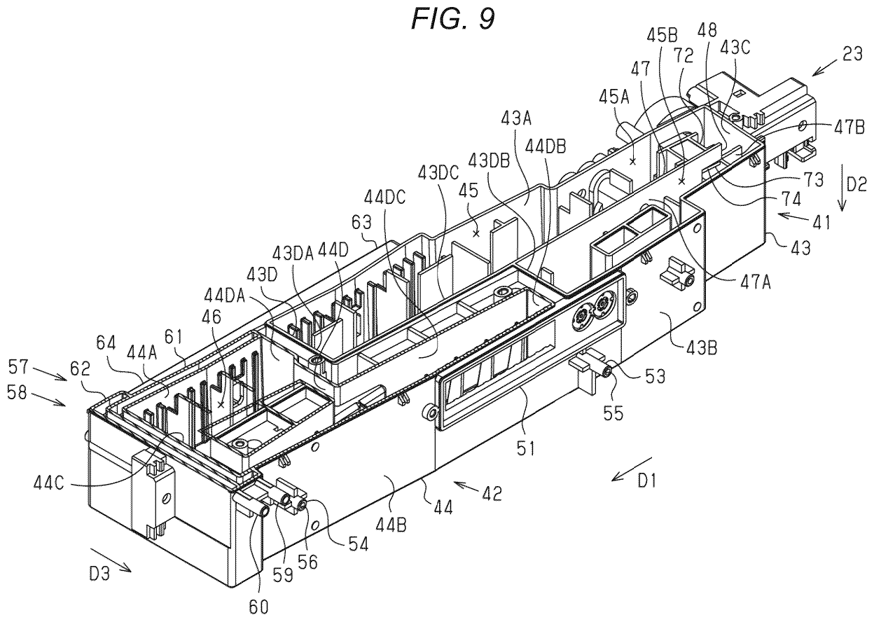

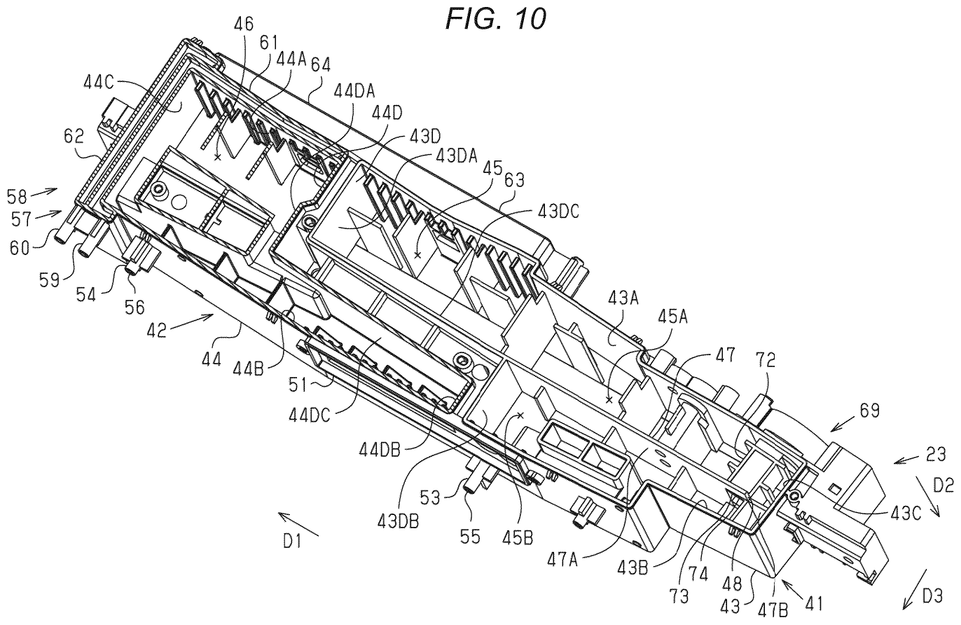

As shown in FIGS. 9 and 10, the tank unit 23 has one or more coupling pipes. In one example, the tank unit 23 includes a first coupling pipe 53 and a second coupling pipe 54. The coupling pipe is a pipe that couples the reservoir to the head 12. The first coupling pipe 53 is a pipe that couples the first reservoir 41 to the head 12. The second coupling pipe 54 is a pipe that couples the second reservoir 42 to the head 12.

The coupling pipe is coupled to the connection flow path. Accordingly, the reservoir is coupled to the head 12. The first coupling pipe 53 is coupled to the first connection flow path 24. The second coupling pipe 54 is coupled to the second connection flow path 25. The coupling pipe extends from the storage body. Specifically, the coupling pipe extends from the lower wall. The first coupling pipe 53 extends from the first lower wall 43B. The second coupling pipe 54 extends from the second lower wall 44B. Through the first coupling pipe 53, the liquid is supplied from the first reservoir 41 to the head 12, or the liquid is returned from the head 12 to the first reservoir 41. The liquid is supplied from the second reservoir 42 to the head 12 through the second coupling pipe 54.

A connection port opens in the coupling pipe. A first connection port 55 opens in the first coupling pipe 53. A second connection port 56 opens in the second coupling pipe 54. The connection port communicates with the storage space. The first connection port 55 communicates with the first storage space 45. Specifically, the first connection port 55 communicates with the second chamber 45B. The second connection port 56 communicates with the second storage space 46.

The first connection port 55 may be located so as not to overlap the through hole 48 when viewed from the vertical direction D3. That is, the first connection port 55 may be located so as not to vertically overlap the through hole 48. In one example, the first connection port 55 may be located so as to be longer in distance from the first coupling sidewall 43C than the through hole 48. Specifically, when the first storage body 43 is viewed from a direction perpendicular to the first front wall 43E, the distance from the first coupling sidewall 43C to the first connection port 55 may be longer than the distance from the first coupling sidewall 43C to the through hole 48. That is, when the first storage body 43 is viewed from the second direction D2, the first connection port 55 and the through hole 48 may be separated from each other. Since the liquid is in contact with air in the through hole 48, the liquid easily foams due to the undulation of the liquid level. Therefore, since the first connection port 55 and the through hole 48 do not vertically overlap each other, air bubbles are less likely to reach the first connection port 55 from the through hole 48. Accordingly, the possibility that air bubbles flow to the head 12 through the first connection port 55 is reduced.

Air bubbles may enter the first reservoir 41 from the first connection port 55 in some cases. For example, air bubbles may be mixed in the liquid returned from the head 12 to the first reservoir 41. In this case, since the first connection port 55 and the through hole 48 do not vertically overlap each other, the air bubbles are less likely to reach the through hole 48 from the first connection port 55. When the air bubbles reach the through hole 48, there is a possibility that the air bubbles are retained in the first chamber 45A. For example, when the air bubbles come into contact with the first liquid sensor 49, there is a possibility that the overflow is erroneously detected. Therefore, the possibility that the overflow is erroneously detected is reduced due to an arrangement in which the first connection port 55 and the through hole 48 do not overlap each other in the vertical direction. In addition, since the air bubbles are less likely to enter the first chamber 45A, the possibility that the air bubbles hinder atmospheric opening in the first chamber 45A is reduced.

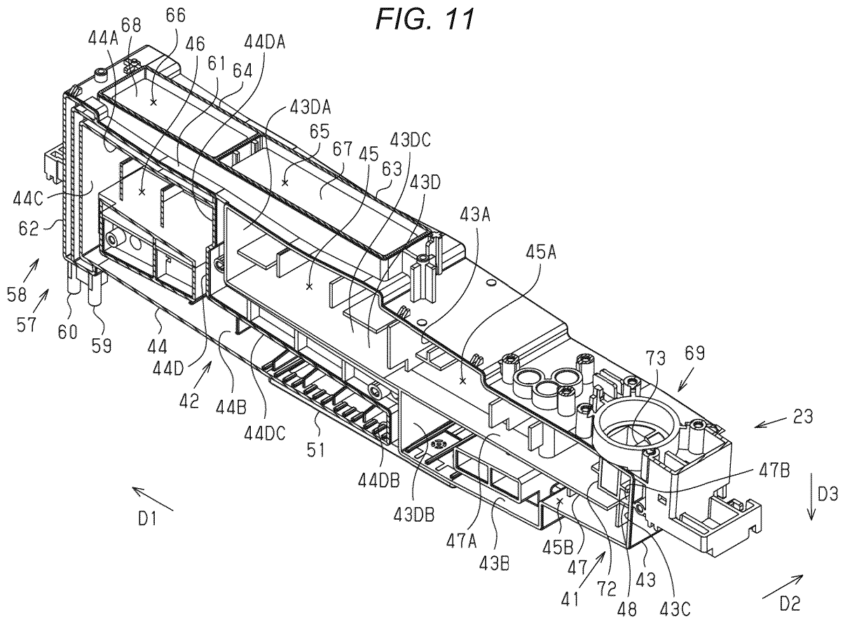

As shown in FIG. 11, the tank unit 23 has one or more atmospheric opening portions. In one example, the tank unit 23 includes a first atmospheric opening portion 57 and a second atmospheric opening portion 58. The atmospheric opening portion is configured to open the inside of the reservoir to the atmosphere. The first atmospheric opening portion 57 is configured to open the inside of the first reservoir 41 to the atmosphere. The first atmospheric opening portion 57 communicates the first storage space 45 with the atmosphere. Specifically, the first atmospheric opening portion 57 communicates the first chamber 45A with the atmosphere. The second atmospheric opening portion 58 is configured to open the inside of the second reservoir 42 to the atmosphere. The second atmospheric opening portion 58 communicates the second storage space 46 with the atmosphere.

The atmospheric opening portion is coupled to the pressure adjustment unit 32. Specifically, the first atmospheric opening portion 57 is coupled to the first air flow path 34. The first atmospheric opening portion 57 communicates the first storage space 45 with the atmosphere through the first air flow path 34. The first atmospheric opening portion 57 may communicate the first storage space 45 directly with the atmosphere. The second atmospheric opening portion 58 is coupled to the second air flow path 35. The second atmospheric opening portion 58 communicates the second storage space 46 with the atmosphere through the second air flow path 35. The second atmospheric opening portion 58 may communicate the second storage space 46 directly with the atmosphere.

The atmospheric opening portion is opened and closed by the opening-closing section 33. That is, the atmospheric opening portion is opened to the atmosphere or blocked from the atmosphere by the opening-closing section 33. The first atmospheric opening portion 57 is opened and closed by the selector valve 37 opening the first air flow path 34 to the atmosphere or blocking the first air flow path 34 from the atmosphere. The second atmospheric opening portion 58 is opened and closed by the selector valve 37 opening the second air flow path 35 to the atmosphere or blocking the second air flow path 35 from the atmosphere.

The atmospheric opening portion includes an opening pipe. The first atmospheric opening portion 57 has a first opening pipe 59. The second atmospheric opening portion 58 has a second opening pipe 60. The opening pipe is a pipe to be coupled to the air flow path. The first opening pipe 59 is coupled to the first air flow path 34. The second opening pipe 60 is coupled to the second air flow path 35.

The atmospheric opening portion has an opening flow path. The first atmospheric opening portion 57 has a first opening flow path 61. The second atmospheric opening portion 58 has a second opening flow path 62. The opening flow path is a flow path communicating with the opening pipe. The opening flow path is a flow path through which air flows. The first opening flow path 61 communicates with the first opening pipe 59. The first opening flow path 61 extends from the first opening pipe 59. The second opening flow path 62 communicates with the second opening pipe 60. The second opening flow path 62 extends from the second opening pipe 60. In one example, the first opening flow path 61 and the second opening flow path 62 extend along the second storage body 44. Specifically, the first opening flow path 61 and the second opening flow path 62 extend along the second coupling sidewall 44C and the second upper wall 44A.

The atmospheric opening portion includes an opening member. The first atmospheric opening portion 57 has a first opening member 63. The second atmospheric opening portion 58 has a second opening member 64. The opening member is coupled to the opening flow path. The opening member extends from the storage body. The opening member extends from the upper wall. The opening member is a member that defines an opening chamber. The opening chamber is a space communicating with the opening flow path. The opening chamber is a space communicating with the storage space. The first opening member 63 is coupled to the first opening flow path 61. The first opening member 63 extends from the first upper wall 43A. The first opening member 63 defines a first opening chamber 65. The first opening chamber 65 communicates with the first opening flow path 61. The first opening chamber 65 communicates with the first storage space 45. Specifically, the first opening chamber 65 communicates with the first chamber 45A. The second opening member 64 is coupled to the second opening flow path 62. The second opening member 64 extends from the second upper wall 44A. The second opening member 64 defines a second opening chamber 66. The second opening chamber 66 communicates with the second opening flow path 62. The second opening chamber 66 communicates with the second storage space 46.

The atmospheric opening portion includes a moisture permeable film. The first atmospheric opening portion 57 has a first moisture permeable film 67. The second atmospheric opening portion 58 has a second moisture permeable film 68. The moisture permeable film is a film that restricts passage of the liquid while allowing passage of a gas. The moisture permeable film is attached to the opening member. The moisture permeable film is located in the opening chamber. The moisture permeable film allows air to flow between the storage space and the opening chamber, while restricting the liquid from flowing out from the storage space to the opening chamber. The first moisture permeable film 67 is attached to the first opening member 63. The first moisture permeable film 67 is located in the first opening chamber 65. The first moisture permeable film 67 allows air to flow between the first storage space 45 and the first opening chamber 65, while restricting the liquid from flowing out from the first storage space 45 to the first opening chamber 65. The second moisture permeable film 68 is attached to the second opening member 64. The second moisture permeable film 68 is located in the second opening chamber 66. The second moisture permeable film 68 allows air to flow between the second storage space 46 and the second opening chamber 66, while restricting the liquid from flowing out from the second storage space 46 to the second opening chamber 66.

As illustrated in FIGS. 5, 6, and 7, the tank unit 23 includes an inflow section 69. The inflow section 69 is configured to cause the liquid to flow from the liquid container 15 into the reservoir. Specifically, the inflow section 69 is configured to cause the liquid to flow from the liquid container 15 into the first reservoir 41. The inflow section 69 causes the liquid to flow from the liquid container 15 into the first reservoir 41 due to the water head difference. The inflow section 69 causes the liquid to flow from the liquid container 15 into the first reservoir 41 through the outflow pipe 17 by causing the air to flow from the first reservoir 41 into the liquid container 15 through the outflow pipe 17.

The inflow section 69 may include a guide pipe 70. The guide pipe 70 is a pipe extending outside the first reservoir 41. The guide pipe 70 extends upward from the first upper wall 43A. The guide pipe 70 is a pipe coupled to the liquid container 15. The guide pipe 70 may be coupled to the liquid container 15 by being inserted into the outflow pipe 17. The guide pipe 70 may be coupled to the liquid container 15 by inserting the outflow pipe 17 into the guide pipe 70.

The inflow section 69 may include a guide valve 71. The guide valve 71 is located in the guide pipe 70. The guide valve 71 is a valve that opens and closes the guide pipe 70. The guide valve 71 may be a check valve. The guide valve 71 is configured to open when the guide pipe 70 is coupled to the liquid container 15.

The inflow section 69 includes an inflow pipe 72. The inflow pipe 72 is a pipe extending in the first reservoir 41. The inflow pipe 72 extends from the first storage body 43. The inflow pipe 72 extends from the first upper wall 43A. The inflow pipe 72 extends downward from the first upper wall 43A. The inflow pipe 72 extends from the first upper wall 43A so as to be coupled to the partition plate 47.

An inflow port 73 opens in the inflow pipe 72. The inflow port 73 is an opening through which the liquid flows. The inflow port 73 communicates with the second chamber 45B. The inflow pipe 72 extends such that the inflow port 73 communicates with the second chamber 45B. The inflow pipe 72 extends from the first upper wall 43A to the second chamber 45B so as to pass through the first chamber 45A. In the inflow pipe 72, the liquid flows from the liquid container 15 to the first reservoir 41 as the air flows from the first reservoir 41 to the liquid container 15. In this way, the liquid is supplied from the liquid container 15 to the first reservoir 41 through the inflow pipe 72.

As shown in FIGS. 9 and 10, the inflow pipe 72 has a tip portion 74. The tip portion 74 is a portion constituting a tip of the inflow pipe 72 extending from the first upper wall 43A. The tip portion 74 is located in the first storage body 43. The inflow port 73 opens in the tip portion 74.

In the tank unit 23, the liquid is supplied from the liquid container 15 to the first reservoir 41 due to the water head difference until the liquid level reaches the tip portion 74. That is, the liquid is supplied from the liquid container 15 to the first reservoir 41 due to the water head difference until the tip portion 74 is blocked by the liquid. When the liquid level reaches the tip portion 74, the air does not flow from the first reservoir 41 to the liquid container 15 through the inflow pipe 72. Accordingly, the supply of the liquid is stopped.

The tip portion 74 may be located so as to be continuous with the partition plate 47. For example, the tip portion 74 may be located at the same height as that of the partition plate 47. The inflow pipe 72 may extend such that the tip portion 74 is flush with the partition plate 47. Since the tip portion 74 is continuous with the partition plate 47, the liquid is supplied from the liquid container 15 to the first reservoir 41 such that the second chamber 45B is filled with the liquid. As a result, the height of the liquid level easily matches the height of the partition plate 47. In this case, since air is unlikely to remain in the second chamber 45B, the liquid is unlikely to foam. The tip portion 74 may be located below the partition plate 47. For example, the inflow pipe 72 may extend so as to penetrate the partition plate 47.

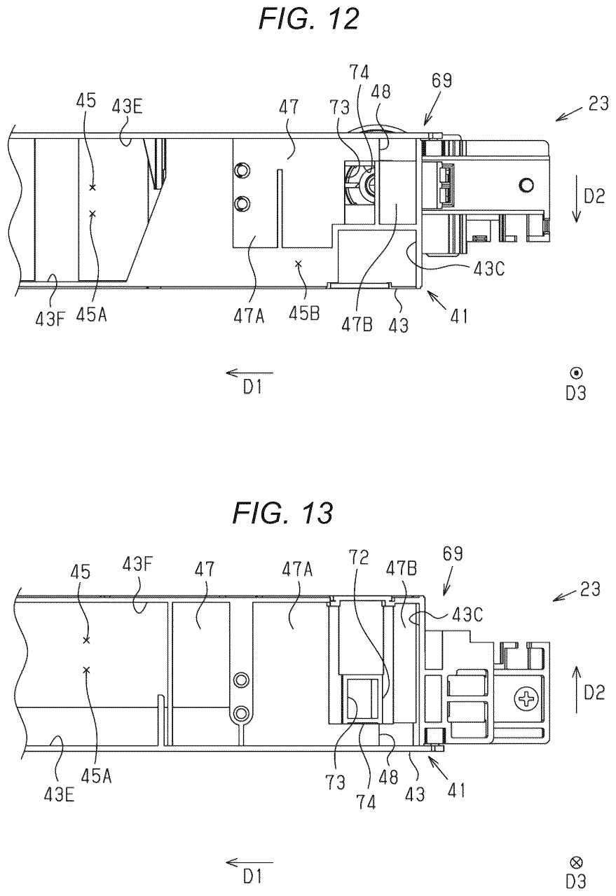

As illustrated in FIGS. 12 and 13, the inflow port 73 is located so as not to overlap the through hole 48 when the first storage body 43 is viewed in front of a viewer from a direction perpendicular to the first front wall 43E. Specifically, the inflow port 73 is located so as not to overlap the through hole 48 on the partition plate 47 when the first storage body 43 is viewed from the second direction D2. That is, the through hole 48 is located so as not to overlap the inflow port 73 when the tank unit 23 is viewed from the front. Accordingly, the liquid is less likely to flow from the second chamber 45B into the first chamber 45A than when the through hole 48 is located so as to overlap the inflow port 73 when the tank unit 23 is viewed from the front.

The inflow port 73 is located so as not to overlap the through hole 48 when the first storage body 43 is viewed in front of the viewer from a direction perpendicular to the first coupling sidewall 43C. Specifically, the inflow port 73 is located so as not to overlap the through hole 48 on the partition plate 47 when the first storage body 43 is viewed from the first direction D1. That is, the through hole 48 is located so as not to overlap the inflow port 73 in a side view of the tank unit 23. Accordingly, the liquid is less likely to flow from the second chamber 45B into the first chamber 45A than when the through hole 48 is located so as to overlap the inflow port 73 in the side view of the tank unit 23.

### State of Tank Unit During Transportation

Then, a state of the tank unit 23 during transportation will be described.

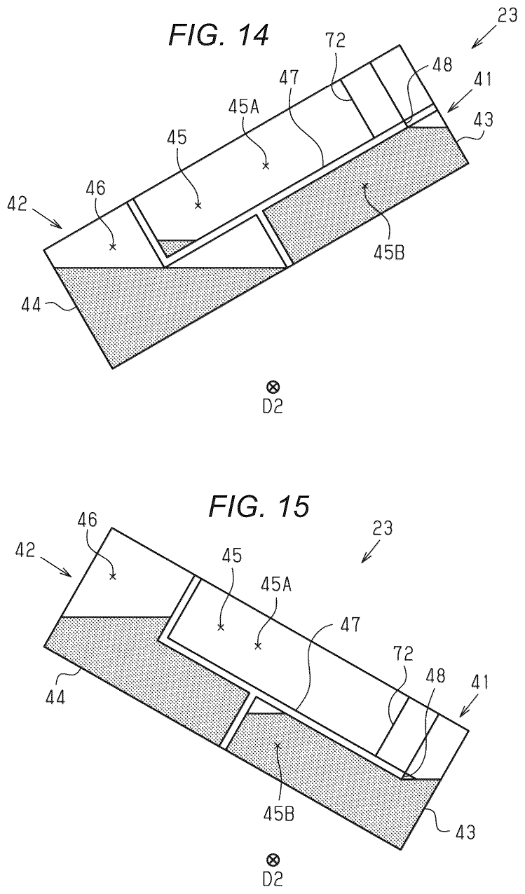

As illustrated in FIGS. 14 and 15, when the liquid level is inclined such that the tank unit 23 swings about the virtual axis extending in the second direction D2, the liquid is likely to remain in the second chamber 45B due to the partition plate 47. That is, the liquid level of the first reservoir 41 is less likely to decrease. Therefore, the liquid level is easily maintained in a state of closing the inflow pipe 72 due to the partition plate 47.

When the state in which the liquid level is inclined continues for a certain period of time, there is a possibility that the liquid flows from the first reservoir 41 to the second reservoir 42 through the joining flow path 51 due to the water head difference. For example, when the posture of the tank unit 23 is changed such that the first reservoir 41 is located above the second reservoir 42, there is a possibility that the liquid flows from the first reservoir 41 to the second reservoir 42. In this case, there is a possibility that the inflow pipe 72 is opened by the liquid level of the first reservoir 41 being lowered. Therefore, when the transportation instruction is received, the controller 40 may close the second atmospheric opening portion 58 by controlling the opening-closing section 33. That is, the controller 40 may block the second reservoir 42 from the atmosphere when the liquid ejection apparatus 11 is transported. Accordingly, the liquid ejection apparatus 11 is maintained in a state where the second reservoir 42 is blocked from the atmosphere even in a power-off state during transportation. By blocking the second reservoir 42 from the atmosphere, the liquid does not flow from the first reservoir 41 to the second reservoir 42. As a result, the liquid level is easily maintained in a state of closing the inflow pipe 72.

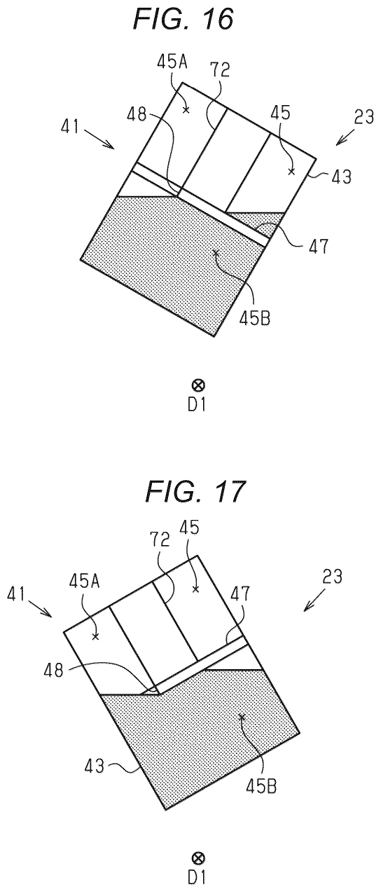

As illustrated in FIGS. 16 and 17, when the liquid level is inclined such that the tank unit 23 swings about the virtual axis extending in the first direction D1, the liquid is likely to remain in the second chamber 45B due to the partition plate 47. That is, the liquid level of the first reservoir 41 is less likely to decrease. Therefore, the liquid level is easily maintained in a state of closing the inflow pipe 72 due to the partition plate 47.

### Functions and Advantages of Embodiment

Then, functions and advantages of the embodiment described above will be described.

(1) The first reservoir 41 includes the first storage body 43 that defines the first storage space 45, and the partition plate 47 that partitions the first storage space 45 into the first chamber 45A and the second chamber 45B. The through hole 48 that communicates the first chamber 45A with the second chamber 45B opens on the partition plate 47. According to the configuration described above, when the liquid level is inclined, the liquid level is less likely to lower due to the partition plate 47. Therefore, when the liquid level is inclined, the inflow port 73 is easily maintained in a state of being blocked by the liquid. This reduces the possibility that the liquid is supplied from the liquid container 15 more than necessary.

(2) The through hole 48 is located so as not to overlap the inflow port 73 when the first storage body 43 is viewed from the direction perpendicular to the first front wall 43E. According to the configuration described above, when the liquid level is inclined, the liquid is less likely to flow from the second chamber 45B into the first chamber 45A.

(3) The through hole 48 is located so as not to overlap the inflow port 73 when the first storage body 43 is viewed from the direction perpendicular to the first coupling sidewall 43C. According to the configuration described above, when the liquid level is inclined, the liquid is less likely to flow from the second chamber 45B into the first chamber 45A.

(4) The partition plate 47 is continuous with the tip portion 74. According to the configuration described above, since the partition plate 47 and the liquid level easily coincide with each other, the liquid hardly foams when the liquid level is inclined.

(5) The partition plate 47 extends horizontally. According to the configuration described above, since the partition plate 47 and the liquid level easily coincide with each other, the liquid hardly foams when the liquid level is inclined.

(6) The through hole 48 opens in the second portion 47B. According to the configuration described above, when the liquid level is inclined, the liquid is less likely to flow from the second chamber 45B into the first chamber 45A.

(7) The volume of the second chamber 45B is smaller than the volume of the first chamber 45A. According to the configuration described above, since the volume of the second chamber 45B is small, the liquid level greatly varies as the liquid increases or decreases. Since the liquid level varies greatly, it is easy to figure out the shortage of the liquid. Further, since the volume of the first chamber 45A is large, the tank unit 23 can store the liquid in the first chamber 45A when the liquid is supplied more than necessary. In addition, since the volume of the first chamber 45A is large, when the liquid enters the first chamber 45A or air bubbles enter the first chamber 45A due to the inclination of the liquid level, the liquid is less likely to come into contact with the first liquid sensor 49, the first moisture permeable film 67, and so on.

(8) When the first storage body 43 is viewed from a direction perpendicular to the first front wall 43E, the distance from the first coupling sidewall 43C to the first upper sidewall 43DA is longer than the distance from the first coupling sidewall 43C to the first lower sidewall 43DB. According to the configuration described above, the tank unit 23 can store the liquid by the first chamber 45A when the liquid is supplied more than necessary.

(9) The through hole 48 is located so as not to overlap the first connection port 55 when viewed from the vertical direction D3. When the liquid level is inclined, air bubbles are generated in some cases in the liquid due to undulation of the liquid between the first chamber 45A and the second chamber 45B through the through hole 48. According to the configuration described above, since the through hole 48 does not vertically overlap the first connection port 55, the possibility that the air bubbles flow from the through hole 48 to the first connection port 55 is reduced. Since the bubbles are less likely to flow to the first connection port 55, the bubbles are less likely to enter the first chamber 45A. Accordingly, the possibility that the air bubbles adhere to the first moisture permeable film 67 or the air bubbles adhere to the first liquid sensor 49 is reduced. In addition, the possibility that air bubbles contained in the liquid returned from the head 12 to the first storage body 43 through the first connection port 55 flow to the through hole 48 is reduced.

(10) When the first storage body 43 is viewed from the front in a direction perpendicular to the first front wall 43E, the distance from the first coupling sidewall 43C to the first connection port 55 is longer than the distance from the first coupling sidewall 43C to the through hole 48. According to the configuration described above, since the through hole 48 and the first connection port 55 are at a distance from each other, the possibility that air bubbles flow from the through hole 48 to the first connection port 55 is reduced. In addition, the possibility that air bubbles flow from the first connection port 55 to the through hole 48 is reduced.

(11) When the transportation instruction is received, the controller 40 controls the opening-closing section 33 to close the second atmospheric opening portion 58. According to the configuration described above, when the liquid level is inclined during transportation, the possibility that the liquid flows from the first reservoir 41 to the second reservoir 42 is reduced. Therefore, the possibility that the liquid is supplied to the first reservoir 41 more than necessary is reduced.

### Technical Ideas

Technical ideas figured out from the embodiment and the modified examples described above, and the functions and advantages thereof will hereinafter be described.

(A) A tank unit is a tank unit configured to be supplied with a liquid from a liquid container and configured to store the liquid to be supplied to a head configured to eject the liquid, the tank unit including a reservoir configured to store the liquid, an inflow section configured to cause the liquid to flow into the reservoir from the liquid container with a water head difference, and an atmospheric opening portion configured to open an inside of the reservoir to an atmosphere, wherein the reservoir includes a storage body configured to define a storage space in which the liquid is stored, and a partition plate configured to partition the storage space into a first chamber and a second chamber, the first chamber is a space that is located above the second chamber and communicates with the atmosphere with the atmospheric opening portion, the inflow section includes an inflow pipe which extends from the storage body toward an inside of the storage body and in which an inflow port communicating with the second chamber opens, and a through hole configured to communicate the first chamber and the second chamber with each other opens in the partition plate. According to the configuration described above, when the liquid level is inclined, the liquid level is less likely to lower due to the partition plate. Therefore, when the liquid level is inclined, the inflow port is likely to be maintained in a state of being blocked by the liquid. This reduces the possibility that the liquid is supplied from the liquid container more than necessary.

(B) In the tank unit, the storage body may include an upper wall, a lower wall facing the upper wall, a coupling sidewall coupled to the upper wall and the lower wall, an opposed sidewall that is coupled to the upper wall and the lower wall and faces the coupling sidewall, a front wall coupled to the upper wall, the lower wall, the coupling sidewall, and the opposed sidewall, and a back wall that is coupled to the upper wall, the lower wall, the coupling sidewall, and the opposed sidewall and faces the front wall, the inflow pipe may extend from the upper wall, and the through hole may be located so as not to overlap the inflow port when viewing the storage body from a direction perpendicular to the front wall. According to the configuration described above, when the liquid level is inclined, the liquid is less likely to flow from the second chamber into the first chamber.

(C) In the tank unit, the storage body may include an upper wall, a lower wall facing the upper wall, a coupling sidewall coupled to the upper wall and the lower wall, an opposed sidewall that is coupled to the upper wall and the lower wall and faces the coupling sidewall, a front wall coupled to the upper wall, the lower wall, the coupling sidewall, and the opposed sidewall, and a back wall that is coupled to the upper wall, the lower wall, the coupling sidewall, and the opposed sidewall and faces the front wall, the inflow pipe may extend from the upper wall, and the through hole may be located so as not to overlap the inflow port when viewing the storage body from a direction perpendicular to the coupling sidewall. According to the configuration described above, when the liquid level is inclined, the liquid is less likely to flow from the second chamber into the first chamber.

(D) In the tank unit, the inflow pipe may include a tip portion located in the storage body, and the partition plate may be continuous with the tip portion. According to the configuration described above, since the partition plate and the liquid level easily coincide with each other, the liquid hardly foams when the liquid level is inclined.

(E) In the tank unit, the partition plate may extend horizontally. According to the configuration described above, since the partition plate and the liquid level easily coincide with each other, the liquid hardly foams when the liquid level is inclined.

(F) In the tank unit, the partition plate may include a first portion extending from the coupling sidewall to the inflow pipe when viewing the storage body from a direction perpendicular to the front wall, and a second portion extending from the opposed sidewall to the inflow pipe when viewing the storage body from the direction perpendicular to the front wall, the first portion may be a portion longer than the second portion when viewing the storage body from the direction perpendicular to the front wall, and the through hole may open in the second portion. According to the configuration described above, when the liquid level is inclined, the liquid is less likely to flow from the second chamber into the first chamber.

(G) In the tank unit, a volume of the second chamber may be smaller than a volume of the first chamber. According to the configuration described above, since the volume of the second chamber is small, the liquid level greatly varies as the liquid increases or decreases. Since the liquid level varies greatly, it is easy to figure out the shortage of the liquid.

(H) In the tank unit, the storage body may include an upper wall, a lower wall facing the upper wall, a coupling sidewall coupled to the upper wall and the lower wall, an opposed sidewall that is coupled to the upper wall and the lower wall and faces the coupling sidewall, a front wall coupled to the upper wall, the lower wall, the coupling sidewall, and the opposed sidewall, and a back wall that is coupled to the upper wall, the lower wall, the coupling sidewall, and the opposed sidewall and faces the front wall, the opposed sidewall may include an upper sidewall configured to define the first chamber, and a lower sidewall configured to define the second chamber, the inflow pipe may extend from the upper wall, and a distance from the coupling sidewall to the upper sidewall may be longer than a distance from the coupling sidewall to the lower sidewall when viewing the storage body from the direction perpendicular to the front wall. According to the configuration described above, the tank unit can store the liquid with the first chamber when the liquid is supplied more than necessary.

(I) The tank unit may include a coupling pipe which is configured to couple the reservoir to the head and in which a connection port opens, wherein the coupling pipe may extend from the lower wall, and the through hole may be located so as not to overlap the connection port when viewed from a vertical direction. When the liquid level is inclined, air bubbles are generated in some cases in the liquid due to undulation of the liquid between the first chamber and the second chamber through the through hole. According to the configuration described above, since the through hole does not vertically overlap the connection port, the possibility that the air bubbles flow from the through hole to the connection port is reduced.

(J) In the tank unit, a distance from the coupling sidewall to the connection port may be longer than a distance from the coupling sidewall to the through hole when viewing the storage body from a direction perpendicular to the front wall. According to the configuration described above, since the through hole and the connection port are at a distance from each other, the possibility that air bubbles flow to the connection port is reduced.

(K) A liquid ejection apparatus includes the tank unit described above and the head. According to the configuration described above, substantially the same advantages as those of the tank unit described above can be obtained.

(L) In the liquid ejection apparatus, the reservoir may be a first reservoir, the atmospheric opening portion may be a first atmospheric opening portion, the tank unit may include a second reservoir to which the liquid is supplied from the first reservoir, a joining flow path coupled to the first reservoir and the second reservoir, and a second atmospheric opening portion configured to open an inside of the second reservoir to the atmosphere, the liquid ejection apparatus may include an opening-closing section configured to open and close the second atmospheric opening portion, and a controller, and the controller may close the second atmospheric opening portion by controlling the opening-closing section when the controller receives a transportation instruction. According to the configuration described above, when the liquid level is inclined during transportation, the possibility that the liquid flows from the first reservoir to the second reservoir is reduced. Therefore, the possibility that the liquid is supplied to the first reservoir more than necessary is reduced.

What is claimed is:

1. A tank unit configured to be supplied with a liquid from a liquid container and configured to store the liquid to be supplied to a head configured to eject the liquid, the tank unit comprising:
a reservoir configured to store the liquid;
an inflow section configured to cause the liquid to flow into the reservoir from the liquid container with a water head difference; and
an atmospheric opening portion configured to open an inside of the reservoir to an atmosphere, wherein
the reservoir includes
a storage body configured to define a storage space in which the liquid is stored, and
a partition plate configured to partition the storage space into a first chamber and a second chamber,
the first chamber is a space that is located above the second chamber and communicates with the atmosphere with the atmospheric opening portion,
the inflow section includes an inflow pipe which extends from the storage body toward an inside of the storage body and in which an inflow port communicating with the second chamber opens, and
a through hole configured to communicate the first chamber and the second chamber with each other opens in the partition plate.

2. The tank unit according to claim 1, wherein
the storage body includes
an upper wall,
a lower wall facing the upper wall,
a coupling sidewall coupled to the upper wall and the lower wall,
an opposed sidewall that is coupled to the upper wall and the lower wall and faces the coupling sidewall,
a front wall coupled to the upper wall, the lower wall, the coupling sidewall, and the opposed sidewall, and
a back wall that is coupled to the upper wall, the lower wall, the coupling sidewall, and the opposed sidewall and faces the front wall,
the inflow pipe extends from the upper wall, and
the through hole is located so as not to overlap the inflow port when viewing the storage body from a direction perpendicular to the front wall.

3. The tank unit according to claim 1, wherein
the storage body includes
an upper wall,
a lower wall facing the upper wall,
a coupling sidewall coupled to the upper wall and the lower wall,
an opposed sidewall that is coupled to the upper wall and the lower wall and faces the coupling sidewall,
a front wall coupled to the upper wall, the lower wall, the coupling sidewall, and the opposed sidewall, and
a back wall that is coupled to the upper wall, the lower wall, the coupling sidewall, and the opposed sidewall and faces the front wall,
the inflow pipe extends from the upper wall, and
the through hole is located so as not to overlap the inflow port when viewing the storage body from a direction perpendicular to the coupling sidewall.

4. The tank unit according to claim 1, wherein
the inflow pipe includes a tip portion located in the storage body, and
the partition plate is continuous with the tip portion.

5. The tank unit according to claim 1, wherein
the partition plate extends horizontally.

6. The tank unit according to claim 2, wherein
the partition plate includes
a first portion extending from the coupling sidewall to the inflow pipe when viewing the storage body from a direction perpendicular to the front wall, and
a second portion extending from the opposed sidewall to the inflow pipe when viewing the storage body from the direction perpendicular to the front wall,
the first portion is a portion longer than the second portion when viewing the storage body from the direction perpendicular to the front wall, and
the through hole opens in the second portion.

7. The tank unit according to claim 1, wherein
a volume of the second chamber is smaller than a volume of the first chamber.

8. The tank unit according to claim 7, wherein
the storage body includes
an upper wall,
a lower wall facing the upper wall,
a coupling sidewall coupled to the upper wall and the lower wall,
an opposed sidewall that is coupled to the upper wall and the lower wall and faces the coupling sidewall,
a front wall coupled to the upper wall, the lower wall, the coupling sidewall, and the opposed sidewall, and
a back wall that is coupled to the upper wall, the lower wall, the coupling sidewall, and the opposed sidewall and faces the front wall,
the inflow pipe extends from the upper wall,
the opposed sidewall includes
an upper sidewall configured to define the first chamber, and
a lower sidewall configured to define the second chamber, and
a distance from the coupling sidewall to the upper sidewall is longer than a distance from the coupling sidewall to the lower sidewall when viewing the storage body from the direction perpendicular to the front wall.

9. The tank unit according to claim 2, further comprising
a coupling pipe which is configured to couple the reservoir to the head and in which a connection port opens, wherein
the coupling pipe extends from the lower wall, and
the through hole is located so as not to overlap the connection port when viewed from a vertical direction.

10. The tank unit according to claim 9, wherein
a distance from the coupling sidewall to the connection port is longer than a distance from the coupling sidewall to the through hole when viewing the storage body from a direction perpendicular to the front wall.

11. A liquid ejection apparatus comprising
the tank unit according to claim 1; and
the head.

12. The liquid ejection apparatus according to claim 11, wherein
the reservoir is a first reservoir,
the atmospheric opening portion is a first atmospheric opening portion,
the tank unit includes
a second reservoir to which the liquid is supplied from the first reservoir,
a joining flow path coupled to the first reservoir and the second reservoir, and
a second atmospheric opening portion configured to open an inside of the second reservoir to the atmosphere,
the liquid ejection apparatus further comprises:
an opening-closing section configured to open and close the second atmospheric opening portion; and
a controller, wherein
the controller closes the second atmospheric opening portion by controlling the opening-closing section when the controller receives a transportation instruction.
